(19) United States
(12) Patent Application Publication
(10) Pub. No.: US 2018/0066093 A1
(43) Pub. Date: Mar. 8, 2018

(54) SILANE-MODIFIED COPOLYMER, MAKING METHOD, AND ADHESION IMPROVER

(71) Applicant: Shin-Etsu Chemical Co., Ltd., Tokyo (JP)

(72) Inventor: Munenao HIROKAMI, Annaka-shi (JP)

(73) Assignee: Shin-Etsu Chemical Co., Ltd., Tokyo (JP)

(21) Appl. No.: 15/691,252

(22) Filed: Aug. 30, 2017

(30) Foreign Application Priority Data
Sep. 7, 2016 (JP) 2016-174727

(51) Int. Cl. C08F 236/06; C09J 109/00

(52) U.S. Cl. CPC C08F 236/06; C09J 109/00

(57) ABSTRACT

A silane-modified copolymer comprising constituent units of butadiene, constituent units having a hydrolyzable silyl group, and constituent units having acid anhydride functionality is low volatile because of its molecular weight. It may be synthesized from relatively inexpensive reactants.

### CROSS-REFERENCE TO RELATED APPLICATION

This non-provisional application claims priority under 35 U.S.C. § 119(a) on Patent Application No. 2016-174727 filed in Japan on Sep. 7, 2016, the entire contents of which are hereby incorporated by reference.

### TECHNICAL FIELD

This invention relates to a silane-modified copolymer, a method for preparing the same, and an adhesion improver. More particularly, it relates to a copolymer of polybutadiene skeleton having an acid anhydride functional group and a hydrolyzable silyl group, a method for preparing the same, and an adhesion improver comprising the same.

### BACKGROUND ART

Organosilicon compounds having both a functional group which is reactive with organic materials as typified by an epoxy, amino, acryloyl, methacryloyl, mercapto or isocyanate group or acid anhydride residue and a functional group which is reactive with inorganic materials such as a hydrolyzable silyl group are generally known as silane coupling agents. They are often used as a medium capable of forming bonds between inorganic materials and organic materials which are otherwise difficult to bond. By virtue of these characteristics, silane coupling agents are widely used as modifiers for inorganic materials and organic materials, adhesive aids for bonding them, and various additives.

Among others, as the organosilicon compound having an acid anhydride residue and a hydrolyzable silyl group, 3-trimethoxysilylpropylsuccinic anhydride and 3-triethoxysilylpropylsuccinic anhydride are commercially available. They find use as a tackifier in pressure-sensitive adhesive compositions (Patent Document 1), a crosslinker in epoxy resin based curable compositions (Patent Document 2), and additives to adhesive compositions (Patent Documents 3 and 4). They are also used in various fields such as a polyimide resin modifier.

It has been demonstrated that organosilicon compounds are effective as the silane coupling agent in a wide variety of applications. The organosilicon compounds, however, still suffer from several problems including high volatility because they are monomers and expensiveness because they are prepared from expensive reactants.

### CITATION LIST

Patent Document 1: JP-A H10-140122

Patent Document 2: JP-A 2006-022158

Patent Document 3: JP-A 2006-282741

Patent Document 4: JP-A 2014-515775 (WO 2012/139965)

### DISCLOSURE OF INVENTION

An object of the invention is to provide a silane-modified copolymer having acid anhydride functionality, which is fully adhesive to inorganic substrates and low volatile, and can be synthesized from relatively inexpensive reactants.

The inventor has found that a copolymer of polybutadiene skeleton having an acid anhydride functional group and a hydrolyzable silyl group is low volatile and fully adhesive to inorganic substrates.

In one aspect, the invention provides a silane-modified copolymer comprising constituent units having the formulae (1), (2) and (3).

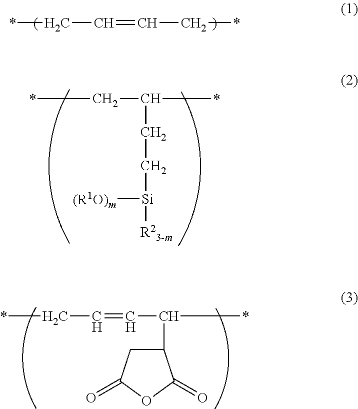

Herein * designates a bond to an adjoining unit, R¹ is each independently a C₁-C₁₀ alkyl group or C₆-C₁₀ aryl group, R² is each independently a C₁-C₁₀ alkyl group or C₆-C₁₀ aryl group, and m is an integer of 1 to 3, with the proviso that the arrangement of constituent units is arbitrary.

Preferably the silane-modified copolymer has a number average molecular weight of at least 1,000.

In another aspect, the invention provides a method for preparing the silane-modified copolymer defined above, comprising the step of effecting hydrosilylation reaction of a copolymer comprising constituent units having the formulae (1), (3) and (4):

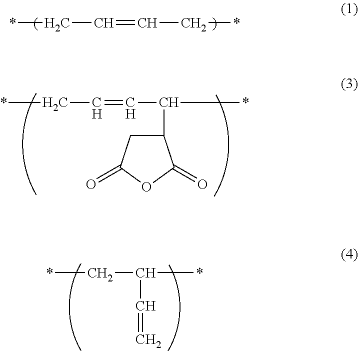

wherein * has the same meaning as above, with an organosilicon compound having the formula (5):

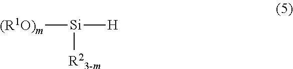

wherein R¹, R² and m are as defined above, in the presence of a platinum compound-containing catalyst.

An adhesion improver comprising the silane-modified copolymer is also contemplated herein.

Throughout the specification, the asterisk (*) in the chemical formula designates a bond to an adjoining unit.

### Advantageous Effects of Invention

The silane-modified copolymer having a polybutadiene skeleton, an acid anhydride functional group, and a hydrolyzable silyl group is low volatile because of its molecular weight and develops tight adhesion when compounded in an adhesive composition.

### DESCRIPTION OF PREFERRED EMBODIMENTS

One embodiment of the invention is a silane-modified copolymer comprising constituent units having the formulae (1), (2) and (3). In the copolymer, the constituent unit of formula (1) is a constituent unit of butadiene, the constituent unit of formula (2) is a constituent unit having a hydrolyzable silyl group, and the constituent unit of formula (3) is a constituent unit having acid anhydride functionality. The arrangement of constituent units is arbitrary.

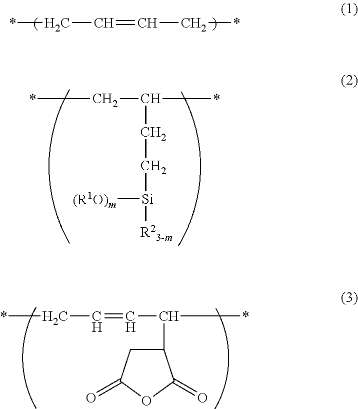

Herein R¹ is each independently a C₁-C₁₀ alkyl group or C₆-C₁₀ aryl group, R² is each independently a C₁-C₁₀ alkyl group or C₆-C₁₀ aryl group, and m is an integer of 1 to 3.

Suitable C₁-C₁₀ alkyl groups may be straight, branched or cyclic and include methyl, ethyl, n-propyl, i-propyl, n-butyl, s-butyl, t-butyl, n-pentyl, n-hexyl, n-heptyl, n-octyl, n-nonyl, n-decyl, cyclopropyl, cyclobutyl, cyclopentyl, cyclohexyl, cycloheptyl, and cyclooctyl. Suitable C₆-C₁₀ aryl groups include phenyl, α-naphthyl and β-naphthyl. Among others, R¹ is preferably a straight alkyl group, more preferably methyl or ethyl. Also R² is preferably a straight alkyl group, more preferably methyl or ethyl.

The silane-modified copolymer should preferably have a number average molecular weight (Mn) of at least 1,000, more preferably at least 2,000 although the Mn is not particularly limited. Notably, Mn is as measured versus polystyrene standards by gel permeation chromatography (GPC).

In the silane-modified copolymer, the constituent units having formulae (1) to (3) are preferably included in a total amount of at least 30 mol %, more preferably at least 50 mol % of the overall units of the copolymer.

For enhancing the tackifying effect of the silane-modified copolymer, the hydrolyzable silyl-containing constituent units having formula (2) are preferably included in an amount of at least 2 mol %, more preferably at least 4 mol %, and the acid anhydride-containing constituent units having formula (3) are preferably included in an amount of at least 1 mol %, more preferably at least 2 mol %, based on the overall units of the copolymer.

In addition to the constituent units of formulae (1) to (3), the silane-modified copolymer may comprise constituent units having the formula (4) and/or constituent units having the formula (7). The arrangement of constituent units is arbitrary as well.

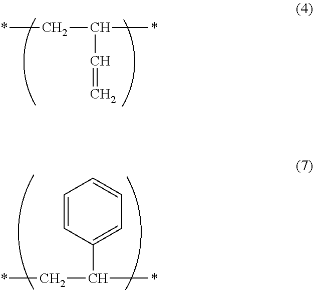

The silane-modified copolymer comprising constituent units of formulae (1) to (3) may be prepared by effecting hydrosilylation reaction of a copolymer comprising constituent units having the formulae (1), (3) and (4) with an organosilicon compound having the formula (5) in the presence of a platinum compound-containing catalyst.

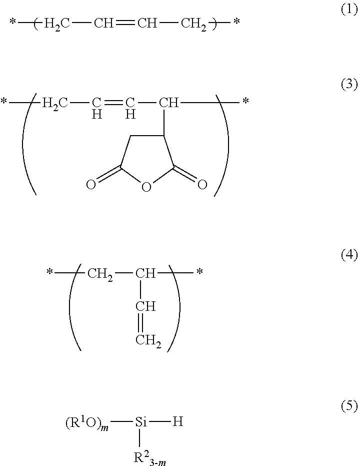

Herein * has the same meaning as above, and R¹, R² and m are as defined above.

The copolymer comprising constituent units having the formulae (1), (3) and (4), i.e., acid anhydride-modified polybutadiene is commercially available. For example, polybutadienes are available under the trade name of Ricon130 MA8, Ricon130 MA13, Ricon130 MA20, Ricon131 MA5, Ricon131 MA10, Ricon131 MA17, Ricon131 MA20, Ricon184 MA6, and Ricon156 MA17 from Cray Valley.

These acid anhydride-modified polybutadienes are available at a very low cost as compared with allylsuccinic anhydride used as the starting reactant for prior art acid anhydride-containing organosilicon compounds. Therefore, the silane-modified copolymers may be synthesized from these polybutadienes at a low cost as compared with the prior art acid anhydride-containing organosilicon compounds.

Examples of the organosilicon compound having formula (5) include trimethoxysilane, triethoxysilane, dimethoxymethylsilane, and diethoxymethylsilane.

The platinum compound-containing catalyst used in hydrosilylation reaction is not particularly limited. Suitable catalysts include chloroplatinic acid, alcohol solutions of chloroplatinic acid, toluene and xylene solutions of platinum-1,3-divinyl-1,1,3,3-tetramethyldisiloxane complex, tetrakistriphenylphosphine platinum, dichlorobistriphenylphosphine platinum, dichlorobisacetonitrile platinum, dichlorobisbenzonitrile platinum, and dichlorocyclooctadiene platinum, as well as supported catalysts such as platinum-on-carbon, platinum-on-alumina and platinum-on-silica. In view of selectivity upon hydrosilylation, zero-valent platinum complexes are preferred, with toluene and xylene solutions of platinum-1,3-divinyl-1,1,3,3-tetramethyldisiloxane complex being more preferred.

The amount of the platinum compound-containing catalyst used is not particularly limited. In view of reactivity and productivity, the catalyst is preferably used in an amount to provide 1×10⁻⁸ to 1×10⁻² mole, more preferably 1×10⁻³ to 1×10⁻³ mole of platinum atom per mole of the organosilicon compound having formula (5).

A solvent may be used although the reaction takes place in a solventless system. Suitable solvents include hydrocarbon solvents such as pentane, hexane, cyclohexane, heptane, isooctane, benzene, toluene, and xylene, ether solvents such as diethyl ether, tetrahydrofuran, and dioxane, ester solvents such as ethyl acetate and butyl acetate, aprotic polar solvents such as N,N-dimethylformamide, and chlorinated hydrocarbon solvents such as dichloromethane and chloroform, which may be used alone or in admixture.

Although the temperature for hydrosilylation reaction is not particularly limited, it is preferably 0° C. to an elevated temperature, more preferably 0 to 200° C. An elevated temperature is preferred for gaining an appropriate reaction rate. In this sense, the reaction temperature is preferably 40 to 110° C., more preferably 40 to 90° C. Although the reaction time is not particularly limited, it is preferably 1 to about 60 hours, more preferably 1 to 30 hours, and even more preferably 1 to 20 hours.

In general, acid anhydride functionality-containing organosilicon compounds are bondable to inorganic substrates such as glass and metals. The silane-modified copolymer of the invention is also useful as an adhesion improver relative to inorganic substrates such as glass and metals. The silane-modified copolymer is a high molecular weight compound having a plurality of hydrolyzable silyl groups and acid anhydride groups in the molecule. When blended in epoxy resins, urethane resins, acrylic resins, polyimide resins, silicone resins or modified silicone resins in an amount of 0.1 to 20% by weight, the silane-modified copolymer helps exert higher adhesion than the prior art acid anhydride-containing organosilicon compounds.

### EXAMPLE

Examples of the invention are given below by way of illustration and not by way of limitation. All parts are by weight (pbw). Mn is a number average molecular weight as measured versus polystyrene standards by gel permeation chromatography (GPC). The viscosity is measured at 25° C. by a rotational viscometer.

### 1) Preparation of Silane-Modified Copolymers

### Example 1-1

A 1-L separable flask equipped with a stirrer, reflux condenser, dropping funnel and thermometer was charged with 207 g of polybutadiene Ricon130 MA (Mn=2,700, consisting of units (1), (3) and (4) in a molar ratio of 67/5/28, by Cray Vally) and an amount (1×10⁻⁵ mol of platinum atom) of toluene solution of platinum-1,3-divinyl-1,1,3,3-tetramethyldisiloxane complex. At an internal temperature of 75-85° C., 122 g of trimethoxysilane was added dropwise over 1 hour to the mixture, which was aged at 80° C. for 3 hours. At the end of aging, the reaction mixture was concentrated under reduced pressure and filtered, obtaining a brown turbid liquid having a viscosity of 6,000 mPa·s and a Mn of 4,300. The Mn data indicated that the silane-modified copolymer consisted of constituent units having formulae (1), (3) and (6) in a molar ratio (1)/(3)/(6) of 67/5/28. This is designated silane-modified copolymer A.

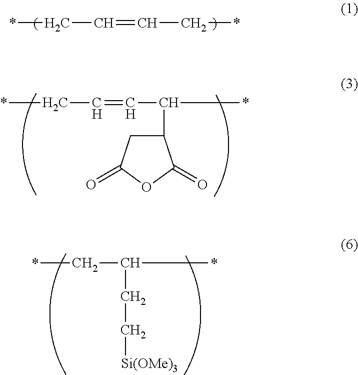

### Example 1-2

A flask as in Example 1-1 was charged with 207 g of polybutadiene Ricon130 MA (Mn=2,700, consisting of units (1), (3) and (4) in a molar ratio of 67/5/28, by Cray Vally) and an amount (0.5×10⁻⁵ mol of platinum atom) of toluene solution of platinum-1,3-divinyl-1,1,3,3-tetramethyldisiloxane complex. At an internal temperature of 75-85° C., 61 g of trimethoxysilane was added dropwise over 1 hour to the mixture, which was aged at 80° C. for 3 hours. At the end of aging, the reaction mixture was concentrated under reduced pressure and filtered, obtaining a brown turbid liquid having a viscosity of 5,700 mPa·s and a Mn of 3,500. The Mn data indicated that the silane-modified copolymer consisted of constituent units having formulae (1), (3), (4) and (6) in a molar ratio (1)/(3)/(4)/(6) of 67/5/14/14. This is designated silane-modified copolymer B.

### Example 1-3

A flask as in Example 1-1 was charged with 207 g of polybutadiene Ricon130 MA (Mn=2,700, consisting of units (1), (3) and (4) in a molar ratio of 67/5/28, by Cray Vally) and an amount (0.5×10⁻⁵ mol of platinum atom) of toluene solution of platinum-1,3-divinyl-1,1,3,3-tetramethyldisiloxane complex. At an internal temperature of 75-85° C., 82 g of triethoxysilane was added dropwise over 1 hour to the mixture, which was aged at 80° C. for 3 hours. At the end of aging, the reaction mixture was concentrated under reduced pressure and filtered, obtaining a brown turbid liquid having a viscosity of 5,200 mPa·s and a Mn of 3,800. The Mn data indicated that the silane-modified copolymer consisted of constituent units having formulae (1), (3), (4) and (8) in a molar ratio (1)/(3)/(4)/(8) of 67/5/14/14. This is designated silane-modified copolymer C.

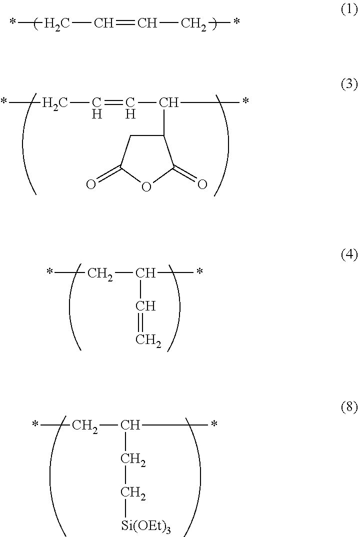

### Example 1-4

A flask as in Example 1-1 was charged with 223 g of polybutadiene Ricon130 MA13 (Mn=2,900, consisting of units (1), (3) and (4) in a molar ratio of 63/9/28, by Cray Vally) and an amount (0.5×10⁻⁵ mol of platinum atom) of toluene solution of platinum-1,3-divinyl-1,1,3-tetramethyldisiloxane complex. At an internal temperature of 75-85° C., 61 g of trimethoxysilane was added dropwise over 1 hour to the mixture, which was aged at 80° C. for 3 hours. At the end of aging, the reaction mixture was concentrated under reduced pressure and filtered, obtaining a brown turbid liquid having a viscosity of 16,000 mPa·s and a Mn of 3,700. The Mn data indicated that the silane-modified copolymer consisted of constituent units having formulae (1), (3), (4) and (6) in a molar ratio (1)/(3)/(4)/(6) of 67/5/14/14. This is designated silane-modified copolymer D.

### Volatility of Silane-Modified Copolymer

The silane-modified copolymers A to D of Examples 1-1 to 1-4, and organosilicon compound E of Comparative Example 1-1 were evaluated for volatility by the following test. It is noted that the organosilicon compound E is 3-trimethoxysilylpropylsuccinic anhydride (X-12-967 by Shin-Elsu Chemical Co., Ltd.).

The test was performed by adding 1 g of a compound (sample) dropwise to an aluminum dish, holding the dish open in a thermostat chamber at 150° C. for 3 hours, and weighing the residue as nonvolatile. A higher nonvolatile value indicates that the compound is low volatile. The test results are shown in Table 1.

TABLE 1

| | Compound | Nonvolatile (%) |
|---|---|---|
| Example 1-1 | Silane-modified copolymer A | 99 |
| Example 1-2 | Silane-modified copolymer B | 99 |
| Example 1-3 | Silane-modified copolymer C | 99 |
| Example 1-4 | Silane-modified copolymer D | 99 |
| Comparative | Organosilicon compound E | 10 |
| Example 1-1 | | |

As seen from Table 1, the silane-modified copolymers A to D of Examples 1-1 to 1-4 are low volatile.

Since the inventive silane-modified copolymer volatilizes little during high-temperature coating, it can develop necessary properties when used in a necessary minimum amount, offering an economic benefit. It causes no or little contamination to the surrounding equipment. An improvement in productivity is also expectable.

### 2) Adhesion Improver

### Examples 2-1 to 2-4 and Comparative Examples 2-1 to 2-3

Epoxy resin compositions were prepared by adding the silane-modified copolymers A to D of Examples 1-1 to 1-4, or organosilicon compound E to an epoxy resin. Notably Comparative Example 2-3 did not contain any organosilicon compound. The epoxy resin compositions were evaluated for adhesion. Specifically, the epoxy resin composition was coated onto a glass plate to a thickness of 10 μm by means of a bar coater, the coating was cured at 150° C. for 1 hour, and the cured coating was tested by a cross-hatch adhesion test according to JIS K 5400. The result is expressed as the number of non-peeled sections per 100 sections.

TABLE 2

| Composition | Example | | | | Comparative Example | | |
|---|---|---|---|---|---|---|---|
| (pbw) | 2-1 | 2-2 | 2-3 | 2-4 | 2-1 | 2-2 | 2-3 |
| Epoxy resin | 98 | 98 | 98 | 98 | 98 | 98 | 98 |
| Catalyst | 2 | 2 | 2 | 2 | 2 | 2 | 2 |
| Silane-modified copolymer A | 0.5 | | | | | | |
| Silane-modified copolymer B | | 0.5 | | | | | |
| Silane-modified copolymer C | | | 0.5 | | | | |
| Silane-modified copolymer D | | | | 0.5 | | | |
| Organosilicon compound E | | | | | 2.0 | 0.5 | |

Test results

| | | | | | | | |
|---|---|---|---|---|---|---|---|
| Adhesion | 100/100 | 100/100 | 100/100 | 100/100 | 80/100 | 50/100 | 30/100 |

Epoxy resin: YDPN638 by Nippon Steel & Sumitomo Metal Corp.
Catalyst: 2-methylimidazole

As seen from Table 2, the inventive silane-modified copolymers are effective for improving the adhesion of epoxy resin compositions to glass even when added in a very small amount.

Japanese Patent Application No. 2016-174727 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A silane-modified copolymer comprising constituent units having the formulae (1), (2) and (3): 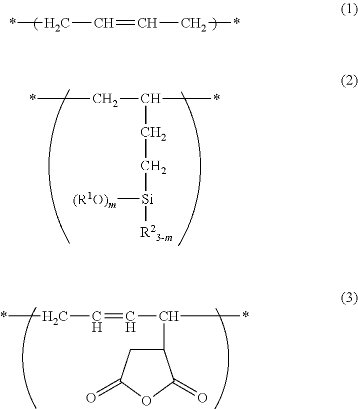
wherein * designates a bond to an adjoining unit, R¹ is each independently a C₁-C₁₀ alkyl group or C₆-C₁₀ aryl group, R² is each independently a C₁-C₁₀ alkyl group or C₆-C₁₀ aryl group, and m is an integer of 1 to 3, with the proviso that the arrangement of constituent units is arbitrary.

2. The silane-modified copolymer of claim 1, having a number average molecular weight of at least 1,000.

3. A method for preparing the silane-modified copolymer of claim 1, comprising the step of effecting hydrosilylation reaction of a copolymer comprising constituent units having the formulae (1), (3) and (4): 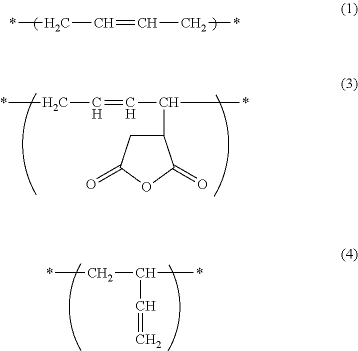
wherein * has the same meaning as above, with an organosilicon compound having the formula (5): 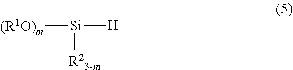
wherein R¹, R² and m are as defined above, in the presence of a platinum compound-containing catalyst.

4. An adhesion improver comprising the silane-modified copolymer of claim 1.
